(19) United States
(12) Patent Application Publication
(10) Pub. No.: US 2006/0177545 A1
(43) Pub. Date: Aug. 10, 2006

(54) Low carbohydrate compositions

(76) Inventors: Lynn Haynes, Morris Plains, NJ (US); Theresa Laffan, Hackettstown, NJ (US); Karen Freyre, Closter, NJ (US); Gary Robert Shortt, Red Lion, PA (US); Sigismondo A. De Tora, Pearl River, NY (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/053,797

(22) Filed: Feb. 9, 2005

(51) Int. Cl. A23G 3/20

(52) U.S. Cl. 426/103

(57) ABSTRACT

Low-carbohydrate compositions derived from mixtures of sugar alcohols are described herein. The compositions of the present invention advantageously maintain a sufficiently high glass transition temperature useful for avoiding cold flow. The food products herein generally retain pleasing organoleptic properties and may be used with any number of snack bars, including nut and/or seed snack bars.

### FIELD OF THE INVENTION

The invention relates to compositions for use in food products made from low digestion, low absorption carbohydrates and methods for producing the same. The composition described herein may be used as a binder and/or coating for food products and advantageously reduces or eliminates cold flow while maintaining pleasing organoleptic properties.

### BACKGROUND

Conventional food products generally utilize of a mixture of sucrose and glucose as a sweetening agent. Sucrose, for example, is commonly used to provide both the sweetness and body in food products, e.g. confectionery products; furthermore, its properties also govern the textural attributes of such products. Recently, however, many consumers have become interested in low carbohydrate diets and wish to avoid food products high in full calorie, fully digestible carbohydrates (e.g. sucrose and/or glucose).

Although a wide variety of alternative sweeteners are commercially available, it is generally considered that sucrose is the optimum sweetener with regard to taste profile and technological properties. Sub-optimal physical properties such as lowered glass transition temperature (Tg), which may be associated with the use of sugar substitutes, such as, for example, sugar alcohols, is correlated with cold flow. For the purposes of discussion herein, cold flow refers to the undesirable property of compositions to loose structural integrity, i.e. to “melt” or “deform” relative to their original shape. As is known in the art, cold flow is directly related to the glass transition temperature. Additionally, cold flow may be exacerbated by a material's tendency to absorb water, i.e. hygroscopicity.

The accepted theory in the scientific community relative to glass transition temperature is that as the molecular weight (MW) of a pure substance increases, cold flow decreases (see “Investigation in the Addition of Polydextrose or HSH to isomalt-Based Hard Candies” of Raudonus et al; “SPI Polyols™: Application Bulletin” of SPI Polyols, Inc., incorporated herein by reference). However, despite the accepted theory that increased molecular weight positively affects cold flow in pure substances, Raudonus et al. found in their study of mixed sugar alcohols, that the Tg of anhydrous combinations of isomalt (MW 344) and polydextrose (MW approx. 2200) drops below the Tg of pure isomalt (63° C.) at a 40:60 ratio. Raudonus et al. further concluded that fairly high amounts (60%-70%) of polydextrose and high molecular types of hydrogenated starch hydrolysate (HSH) in isomalt blends are needed to increase Tg effectively, compared to pure isomalt. Additionally, Raudonus found that the addition of low molecular HSH causes a reduction of Tg of about 10° C. to 15° C. compared to pure isomalt. Food Research International 33 (2000) 41-51, found that anhydrous blends of isomalt and maltitol syrup solids, especially in ratios of 50:50 to 90:10 (isomalt to maltitol syrup solid basis), have a lower glass transitional temperatures than isomalt or maltitol cooked alone.

Therefore, it is an object of the present invention to develop a sweetener mixture that can be used as a binder or coating, that includes carbohydrates having lower calorie (i.e. <4 cal/g), lower digestion and absorption, while preserving desired characteristics such as high glass transition temperature and reduced cold flow. These and other objects and advantages of the present invention will be apparent to those skilled in the art upon consideration of the present disclosure.

### SUMMARY

A low carbohydrate coating made from low digestion, low absorption carbohydrates (i.e. <4 cal/g) is provided that includes a blend of sugar alcohols. The coating has a high glass transition temperature and reduced cold flow which allows the coating to be blended with other foods or used as a coating or binder composition that when formed holds shape and is not sticky. The coating may be added to, or coated over, foods such as nuts, seeds, cereal pieces, grains, cookies, crackers, and mixtures thereof.

In one aspect, a coating composition is provided that includes a blend of disaccharide sugar alcohol and long-chain hydrogenated saccharides having a degree of polymerization (DP) of greater than 3, in amounts effective for providing a coating with a Tg of about 95° F. or greater at a moisture content of about 1 to about 4 percent. The coating composition is low in fully digestible carbohydrates as it includes less than about 1 gram of fully digestible carbohydrate per 100 grams of total coating composition. The coating may further include a limited amount of monosaccharide sugar alcohol and polysaccharide sugar alcohol having a DP of 3.

The primary carbohydrate component of the coating composition is a disaccharide sugar alcohol which is effective in providing the coating with melt-in-your-mouth quality and desired sweetness. In this aspect, the coating composition includes from about 50 to about 90 weight percent disaccharide sugar alcohol. Disaccharide sugar alcohols which may be used include isomalt, maltitol, lactitol and mixtures thereof. In an important aspect, the coating composition includes from about 70 to about 80 weight percent maltitol.

The coating composition also includes from about 10 to about 50 weight percent long-chain hydrogenated saccharide. Longer chain polysaccharides, DP>3 are effective for providing a coating with optimal texture and are further effective for modifying the Tg of the coating. Long-chain hydrogenated saccharides which may be used include hydrogenated starch hydrolysates and hydrogenated maltitol sweetener syrups.

The coating composition may further include from about 0 to about 3 weight percent monosaccharide sugar alcohol. The monosaccaride content is held to about 3 weight percent or less to control hydroscopicity. Monosaccharide sugar alcohols which may be used include sorbitol, erythritol, mannitol, xylitol, and mixtures thereof. In an important aspect, the coating composition includes from about 0.5 to about 1.2 weight percent sorbitol.

The coating composition may further include from about 0 to about 3 weight percent polysaccharide sugar alcohol. Polysaccharide sugar alcohols which may be used include hydrogenated maltotriose. In an important aspect, the food composition includes from about 0 to about 1 weight percent hydrogenated maltotriose.

In another aspect, a food product is provided that includes a foodstuff coated with a low carbohydrate coating composition made with low digestion, low absorption carbohydrates (i.e. <4 cal/g). The coating composition includes a blend of disaccharide sugar alcohol and long-chain hydrogenated saccharides in amounts effective for providing a coating composition with a Tg of 95° F. or greater at a moisture content of 1 to 4 percent. The coating composition has less than about 1 gram of fully digestible carbohydrate per 100 grams of coating composition. Foodstuffs that may be used include nuts, seeds, cereal pieces, grains, cookies, crackers, and mixtures thereof.

In one aspect, a process is provided for forming a coating composition. The process includes blending a disaccharide sugar alcohol and long-chain hydrogenated saccharides in amounts effective for providing a coating composition with a Tg of 95° F. or greater at a moisture content of 1 to 4 percent. The coating composition has less than 1 gram of fully digestible carbohydrate per 100 gram of coating composition.

In another aspect, a process is provided for preparing a food product coated with a low carbohydrate coating composition made with low digestion, low absorption carbohydrates (i.e. <4 cal/g). The process includes forming a coating composition and applying that coating composition to a foodstuff. The coating composition includes a disaccharide sugar alcohol and long-chain hydrogenated saccharides in amounts effective for providing a coating composition with a Tg of 95° F. or greater at a moisture content of 1 to 4 percent. Foodstuffs that may be used include nuts, seeds, cereal pieces, grains, cookies, crackers, and mixtures thereof. The food product has 1 g sugar or less per 35 g of food product and less than 12% fully digestible carbohydrates.

### BRIEF DESCRIPTION OF THE DRAWING

FIG. 1 provides a process diagram for the production of low-carbohydrate peanut bars made for low digestion, low absorption carbohydrates (i.e. <4 cal/g).

### DETAILED DESCRIPTION

A low calorie (<4 cal/g), low digestion carbohydrate composition derived from mixtures of sugar alcohols is provided. The blend of components in the coating composition is effective for maintaining a sufficiently high glass transition temperature useful for avoiding cold flow, maintaining a crispy, crunchy texture over the coatings shelf-life with reduced stickiness, and for providing a sweet melt-in-your-mouth flavor.

As used herein, low carbohydrate content refers to a food composition or coating having less than about 50 weight percent of full calorie, fully digestible carbohydrates, and preferably less than about 12 percent fully digestible carbohydrates. Low carbohydrate content may be further defined as a food composition or coating having less than about 0.5 grams of full calorie (i.e. 4 cal/g), fully digestible carbohydrate per gram, preferably less than about 0.12 grams of carbohydrate per gram of food composition or food coating. Low digestion and absorption carbohydrates refers to sugar alcohols which are not as digestible or as readily absorbed as corresponding carbohydrates which are fully digestible.

In one embodiment, the composition maintains a glass transition temperature of about 95° F. and above at a target moisture in the range of 1 to 4 percent; thus, ensuring processing capability and shelf-life through distribution and storage. In another embodiment, the composition maintains a glass transition temperature of at least about 95° F. at a target moisture at about 2%. However, it should be understood that any glass transition temperature sufficiently high to avoid or reduce cold flow is acceptable. The minimum Tg to provide acceptable reduced cold flow is about 80° F. (i.e. product storage temperature, usually about room temperature (70° F.) plus 10 degrees). It should also be understood that the target moisture may vary according to cooking conditions such as pressure, ingredients, etc. In any case, target moisture may vary so long as a sufficiently high glass transition temperature is achieved such that cold flow is reduced or completely avoided. Avoidance/reduction of cold flow in the sugar alcohol mixtures advantageously increases shelf-life for food products utilizing such sugar alcohol mixtures.

Additionally, the mixtures described herein have been formulated to deliver pleasing organoleptic properties. For example, in one embodiment, the sugar alcohol coating is clear and transparent; thus, allowing for nut/seed visibility. In another embodiment, the coating delivers a sweet-savory flavor. In another embodiment, the coating is crispy-crunchy. In another embodiment the coating is light, i.e. “melt-in-your-mouth”. Different variations of the sugar alcohol coating may include any combination of the aforementioned properties, as well as additional properties.

Although the sugar alcohol blends described herein may be used with any number of food products, the coating as described herein is especially useful as a coating/binder for nut and/or seed bar snacks, cereal pieces, grains, cookies, crackers, and mixtures thereof. In the case of nut and/or seed bars; however, the nuts and/or seeds may be whole or halved depending on the recipe. As a binder, the sugar alcohol blends may be used to bind the nuts and/or seeds. In one embodiment, the coating/binder comprises approximately 35% of the food product and the nuts and/or seeds comprise the remaining 65%. However, it should be understood that any ratio of coating/binder to nuts and/or seeds may be used. In another embodiment, the food product containing a coating/binder, as described herein, and nuts and/or seeds may be wholly or partially enrobed in chocolate, caramel, and the like. In the case that a caramel, chocolate, or other layer is added to the snack bar, the ratios may vary from the aforementioned 35% coating/binder to 65% nuts and/or seeds.

Sugar alcohols, also known as polyols, polyhydric alcohols, or polyalcohols, are the hydrogenated forms of sugars. For example, in the case of aldoses, the aldehyde group, i.e. —CHO, is replaced with a —CH₂OH group. In the case of a ketoses, the ketone group, i.e. —C═O, is replaced with a —CH₂OH group. Sugar alcohols can be derived from sugars consisting of one or more simple sugars, such as for example, monosaccharides, disaccharides, and polysaccharides. Sugar alcohols may be characterized by their degree of polymerization (DP). A monosaccharide based sugar alcohol is characterized as DP1 while a disaccharide based sugar alcohol is characterized as DP2. A polysaccharide is a sugar consisting of three monosaccharides or more and the corresponding sugar alcohol is characterized as DP3. Examples of DP1 sugar alcohols include sorbitol (also known as glucitol), erythritol, mannitol, and xylitol. Another monosaccaride that may be used includes Tagatose (an isomer of glucose which is not a sugar alcohol). Examples of DP2 sugar alcohols include isomalt, maltitol, and lactitol. Examples of DP3 sugar alcohols include hydrogenated maltotriose.

In another embodiment a sugar alcohol/polysaccharide pre-blend is blended with isomalt to provide a food composition that can also be used as a coating. In this aspect, the sugar alcohol/polysaccharide pre-blend is blended with isomalt in an amount effective to provide a food composition with a Tg of 95° F. or greater at a moisture content of about 1 to about 4%. More specifically, about 10 to about 50 weight percent, preferably about 20 to about 30 weight percent alcohol/polysaccharide pre-blend is blended with about 50 to about 90 weight percent, preferably about 70 to about 80 percent isomalt. Isomalt used to partially replace maltitol in the coating increases Tg and decreases hygroscopicity of the binder. However, isomalt alone has a reduced Tg compared to the preblend plus isomalt. Furthermore, isolmalt tends to be brittle, have low sweetness and not be as well tolerated in the human digestive system.

One example of an alcohol/polysaccharide pre-blend is Lycasin® HBC available from Roquette America Inc. Lycasin® HBC is a maltitol syrup that is comprised of maltitol and hydrogenated polysaccharides of closely controlled size distribution. The carbohydrate formulation gives Lycasin® HBC a unique set of properties that facilitates processing and provides sugar-free food products. The composition of Lycasin® HBC is as follows:

Composition (dry substance basis)

Sorbitol (3% max) = DP1H
Maltitol (50-55%) = DP2H
Hydrogenated oligosaccharides = DP3H (low level)
Hydrogenated polysaccharides = DP3⁺H (40-50%)
Dry substance: 73%
Reducing sugars: 0.15% max

For more information pertaining to Lycasin® HBC see “Lycasin® HBC: An unique maltitol syrup for sugar-free hard boiled candies” of Roquette America, Inc., incorporated herein by reference. Lycasin HBC at 4.7% moisture has a Tg of 128.7° F.

Isomalt is a 98% pure coarse white powder derived exclusively from sucrose. Chemically, isomalt belongs to the class of disaccharide polyols like maltitol and lactitol. Isomalt consists of two components in a 1:1 ratio, 1,6-glucopyranosyl-D-sorbitol (GPS) and 1,1 glucopyranosyl-D-mannitol (GPM). Isomalt is chemically stable and, therefore, resists Maillard reactions (browning). Pure isomalt has a low water solubility (28% at 25□C). This solubility increases with increasing temperature. An isomalt syrup available from Cerestar (ClsoMaltidex LQ 16510) exhibits similar properties as isomalt powder, but does not require the dissolution step during the manufacturing of confectionery products. Isomalt based candies tend not to absorb water. This stability against moisture pick-up (i.e. hygroscopicity) contributes to an extended shelf life of the products. Isomalt-based hard candies show a better storage stability than other traditional hard-boiled sweets.

The glass transition temperature (Tg) of isomalt is above room temperature. For example, the Tg of Isomalt ST at a moisture of 3.77% is about 118° F. Therefore, at room temperature isomalt is in a glassy state and will not crystallize (since crystallization can only occur at temperature above Tg).

In another aspect, a sugar alcohol/polysaccharide pre-blend may be blended with maltitol to provide a food composition. In this aspect, about 20 to about 80 weight percent, preferably about 40 to about 50 weight percent alcohol/polysaccharide pre-blend is blended with about 20 to about 80 weight percent, preferably about 50 to about 60 weight percent maltitiol. Maltitol has a sweet, melt-in-your-mouth characteristic, much like sugar. Maltitol gives a crispy, crunch texture and is well tolerated by the human digestive system.

In one such aspect, Lycasin®, HBC is blended with maltitol. Maltitol powders or syrups range from 50 to 89% in maltitol purity. Maltitol has no aftertaste like some of the other polyols. Like other polyols, maltitol is slowly absorbed by the system and maltitol is available from Cerestar, Roquette, SPI Polyols, Inc. and Towa Chemical Industry Co., LTD.

In another aspect, a coating may be provided by blending less than about 50 weight percent, preferably 20 to 30 weight percent matitol with isomalt. Additonal polysaccharides would not be needed in the blend.

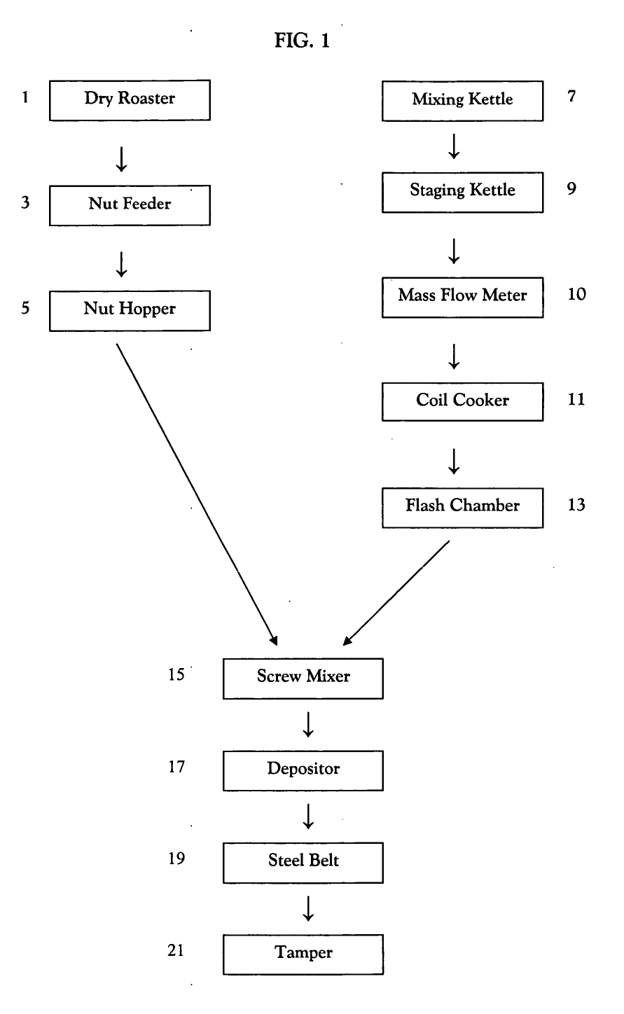

Turning now to FIG. 1, a process diagram for one embodiment of the production of low-carbohydrate peanut bar is shown. Shown are a dry roaster 1, a nut feeder 3, a nut hopper 5, mixing kettle 7, staging kettle 9, flow meter 10, coil cooker 11, flash chamber 13, screw mixer 15, depositor 17, belt 19, and tamper 21.

The peanuts and binder/coating composition are prepared separately. Peanuts are roasted in the dry roaster 1. From the dry roaster 1, the dried peanuts are dispensed through the nut feeder 3 into the nut hopper 5. From the nut hopper 5, nuts are transferred to the screw mixer 15 where the nuts are combined with the binder/coating mixture.

Separately, raw materials for the binder/coating composition are manually weighed and added to the mixing kettle 7 where the ingredients are thoroughly mixed and heated to 230° F. (plus or minus 3° F.). From the mixing kettle 7, the mixture is pumped into the staging kettle 9. The temperature in the staging kettle 9 is maintained at 200° F. to 230° F., preferably 222° F. to 228° F. The binder/coating base is transferred through a coil cooker 11 where the product temperature is increased to approximately 340° F. to 360° F., preferably 347° F. to 353° F.

Flow rate through the coil cooker 11 is controlled using a feedback loop from a mass flow meter 10 located between the staging kettle 9 and the coil cooker 11. In order to maintain the cook temperature in the coil cooker 11 at about 340° F. to about 360° F., preferably 347° F. to about 353° F., steam pressure in the coil cooker 11 chamber is held at 150 (plus or minus 5 psig). The desired flow rate of the cooked binder/coating is 7.75 pounds per minute. For example, assuming the moisture content of the uncooked binder/coating mixture is 24.35% and the finished “cooked” binder/coating mixture is 2.0%, a moisture target of 9.72 pounds of binder/coating per minute is fed into the coil cooker 11, thus achieving a flow rate of 7.75%. From the coil cooker 11, the product is discharged into the flash chamber 13 where excess vapor is removed and the cooked binder/coating mixture drops into the screw mixer 15.

Color, flavor, peanut oil, and peanuts are metered into the screw mixer 15. All of the ingredients are mixed together and discharged via the depositor 17 unto a stainless steel belt 19 where the food product is formed into sheets approximately 0.5 inches thick and 40 inches wide by way of the tamper 21. The food product is cooled on the belt 19 into two cooling zones. The front end of the belt 19 is held at about 110° F. to about 130° F., preferably about 117° F. to about 123° F., and the back end is held at about 85° F. to about 105° F., preferably 92° F. to about 98° F. The food product is cut into bars and transferred to the packaging area where they are wrapped.

This production procedure is advantageously designed to work with commonplace manufacturing facilities such that minimal modifications are needed. Although described for use with peanuts, is should be understood that the aforementioned process maybe used with other types of nuts and/or seeds.

The following examples illustrate the invention and are intended to further describe and not to limit the invention. All percentages used herein are by weight, unless otherwise indicated.

### EXAMPLE 1

### Low Carbohydrate Peanut Bar: Maltitol Based Mixture

An approximately 80% maltitol, i.e. less than or equal to 80%, (DP2) mixture was prepared for binding peanuts. Other ingredients in the syrup mixture included <1% sorbitol (DP1), <1% hydrogenated maltotriose (DP3), and long-chain hydrogenated saccharides (i.e. >DP3). The long-chain hydrogenated saccharides are a mixture of length ranging in molecular weight from 700 to 1800 and represented the remaining (approximately 19%) of the coating syrup solids (see Lycasin® formula above). The binding mixture accounted for 35.29% of the end product and peanuts accounted for the remaining 64.71%.

Binding Formula

| Ingredient | Percent (DWB) |
|---|---|
| Maltitol | 57 |
| Lycasin ®, HBC | 38 |
| Flavor | 2 |
| Peanut Oil | 1 |
| Salt | 2 |
| Water | 0 |
| Total | 100 |

DWB is dry weight basis.

Peanuts used in the low carbohydrate peanut bar were roasted for 25 minutes at 300° F.

To produce the binding mixture, crystalline maltitol, water, and Lycasin® were mixed together according to the above formula. The resulting mixture was cooked until the temperature reached 228° F. in a covered kettle. The mixture was transferred from the cooking kettle to a hold kettle where the temperature was held at 222° F. Then the mixture was pumped to a heating coil where the mixture was cooked until a temperature of 358° F. The resulting syrup mixture was delivered to a screw mixer. The cooked syrup mixture was fed to the screw mixer at a rate of 54.47 lbs per hour while the roasted peanuts were added at 100 lbs per hour. From the screw mixer, the coated nuts were tampered into a uniform sheet having a thickness of 0.45 inches. The sheet was then cut into rectangular bars having dimensions of 3.7 inches by 1.5 inches. The resulting nut bar had only 1 g of sugar (simple carbohydrate) per 35 g snack bar (i.e. 2.85 percent simple carbohydrate, i.e. less than 50 percent carbohydrate, i.e. less than 12 percent fully digestible carbohydrate). Simple carbohydrates may include a sugar (DP1 or 2) whereas carbohydrate can include a variety of polyhydric compounds of varying length. Moisture content equaled about 1.9%.

### EXAMPLE 2

### Low Carbohydrate Peanut Bar: Isomalt Based Mixture

A 73% isomalt mixture was prepared for binding peanuts. Other ingredients in the syrup mixture included 12% maltitol, <1% sorbitol (DP1), <1% hydrogenated trisaccharide (DP3), and 11% long-chain hydrogenated saccharides (i.e. >DP3) represented the remaining 23% of the coating syrup solids (see Lycasin® formula above). The binding mixture accounted for 35.3% of the end product and peanuts accounted for the remaining 64.71%.

Binding Formula

| Ingredient | Percent (DWB) |
|---|---|
| Isomalt | 73 |
| Lycasin ®, HBC | 23 |
| Flavor | 2 |
| Peanut Oil | 1 |
| Salt | 2 |
| Water | 0 |
| Total | 100 |

Peanuts used in the low carbohydrate peanut bar were roasted for 25 minutes at 300° F.

To produce the binding mixture, crystalline isomalt, water, and Lycasin® were mixed together according to the above formula. The resulting mixture was cooked until the temperature reached 228° F. in a covered kettle. The mixture was transferred from the cooking kettle to a hold kettle where the temperature was held at 222° F. Then the mixture was pumped to a heating coil where the mixture was cooked until a temperature of 358° F. The resulting syrup mixture was delivered to a screw mixer. The cooked syrup mixture was fed to the screw mixer at a rate of 54.5 lbs per hour while the roasted peanuts were added at 100 lbs per hour. From the screw mixer, the coated nuts were tampered into a uniform sheet having a thickness of 0.45 inches. The sheet was then cut into rectangular bars having dimensions of 3.7 inches by 1.5 inches.

The resulting nut bar had only 1 g of sugar (simple carbohydrate) per 35 g snack bar (i.e. 2.85 percent simple carbohydrate, i.e. less than 12 percent fully digestible carbohydrate, i.e. less than 8 percent simple carbohydrate). Moisture content equaled 3.0295%.

### EXAMPLE 3

### Determination of Lycasin Tg

A low moisture (i.e. 4.7%) Lycasin, HBC candy glass is prepared by cooking the Lycasin syrup at atmospheric pressure to 330 F. Moisture content of the cooked glass is determined by Karl Fischer moisture measurement. The Tg property of Lycasin HBC at a moisture of 4.7% is determined by DSC according to the following procedure.

Instrument: TA Instruments Q1000 Auto MDSC, Q series RCS unit and the TA5000 Advantage Software Suite

Sample pans: Perkin-Elmer Stainless Steel O-ring pans

Sample preparation: The sample is weighted into a DSC pan, in amount of 35 mg to 45 mg

Instrument calibration: The modulated DSC is calibrated for baseline, cell constant, temperature and heat capacity in known manner

DSC method:
a. Heat to 110 C at 20 C/min
b. Isothermal for 2 min
c. Cool to −20 C
d. Isothermal for 2 min
e. Modulate +/−0.5 C every 80 sec
f. Data storage on
g. Heat 4 C/min to 100 C

### EXAMPLE 4

### Determination of Isomalt Tg

A low moisture (i.e. 3.8%) Isomalt candy glass is prepared by mixing 117 g of Isomalt powder with 35 g of water, then cooking the mixture at atmospheric pressure to 359° F. Moisture content of the cooked glass is determined by Karl Fischer moisture measurement. The Tg property of Isomalt at a moisture of 3.8% moisture is determined by DSC according to the procedure above.

All references cited in the present specification are incorporated by reference.

What is claimed is:

1. A coating composition comprising a blend of a disaccharide sugar alcohol and long-chain hydrogenated saccharides in amounts effective for providing a food composition with a Tg of 95° F. or greater at a moisture content of 1 to 4 percent, the coating composition having less than 1 gram of fully digestible carbohydrate per 100 grams of coating composition.

2. The coating composition of claim 1 wherein the coating includes from about 50 to about 90 weight percent disaccharide sugar alcohol selected from the group consisting of isomalt, maltitol, lactitol, and mixtures thereof.

3. The coating composition of claim 2 wherein the disaccharide sugar alcohol is maltitol.

4. The coating composition of claim 1 wherein the coating includes from about 10 to about 50 weight percent long-chain hydrogenated saccharide selected from the group consisting of long-chain hydrogenated saccharides.

5. The food composition of claim 4 wherein the long-chain hydrogenated saccharide has a degree of polymerization of greater than 3.

6. The coating composition of claim 1 wherein the coating includes from about 0 to about 3 weight percent monosaccharide sugar alcohol selected from the group consisting of sorbitol, erythritol, mannitol, xylitol, and mixtures thereof.

7. The coating composition of claim 6 wherein the monosaccharide sugar alcohol is sorbitol.

8. The coating composition of claim 1 wherein the coating includes from about 0 to about 3 weight percent polysaccharide sugar alcohol.

9. The coating composition of claim 8 wherein the polysaccharide sugar alcohol is hydrogenated maltotriose.

10. The coating composition of claim 1 wherein the coating is added to foods selected from the group consisting of nuts, seeds, cereal pieces, grains cookies, crackers, and mixtures thereof.

11. A food product comprising a foodstuff coated with a low carbohydrate coating composition, the coating composition comprising a blend of a disaccharide sugar alcohol and long-chain hydrogenated saccharides in amounts effective for providing a food composition with a Tg of 95° F. or greater at a moisture content of 1 to 4 percent, the coating composition having less than 1 gram of fully digestible carbohydrate per 100 grams of coating composition.

12. The food product of claim 11 wherein the coating includes from about 50 to about 90 weight percent disaccharide sugar alcohol selected from the group consisting of isomalt, maltitol, lactitol, and mixtures thereof.

13. The food product of claim 12 wherein the disaccharide sugar alcohol is maltitol.

14. The food product of claim 11 wherein the coating includes from about 10 to about 50 weight percent long-chain hydrogenated saccharide selected from the group consisting of long-chain hydrogenated saccharides.

15. The food product of claim 14 wherein the long-chain hydrogenated saccharide has a degree of polymerization of greater than 3.

16. The food product of claim 11 wherein the coating composition further comprises from about 0 to about 3 weight percent monosaccharide sugar alcohol selected from the group consisting of sorbitol, erythritol, mannitol, xylitol, and mixtures thereof.

17. The food product of claim 11 wherein the monosaccharide sugar alcohol is sorbitol.

18. The food product of claim 11 wherein the coating composition includes from about 0 to about 3 weight percent polysaccharide sugar alcohol.

19. The food product of claim 18 wherein the polysaccharide sugar alcohol is hydrogentated maltotriose.

20. The food product of claim 11 wherein the coating is applied to foodstuffs selected from the group consisting of nuts, seeds, cereal pieces, grains cookies, crackers, and mixtures thereof.

21. The food product of claim 11 wherein the resulting food product has 1 g sugar or less per 35 g of food product and less than 12% fully digestible carbohydrates.

22. A process for preparing a coating composition comprising blending a disaccharide sugar alcohol and long-chain hydrogenated saccharides in amounts effective for providing a food composition with a Tg of 95° F. or greater at a moisture content of 1 to 4 percent, the coating composition having less than 1 gram of fully digestible carbohydrate per 100 gram of coating composition.

23. The process of claim 22 wherein the coating includes from about 50 to about 90 weight percent disaccharide sugar alcohol selected from the group consisting of isomalt, maltitol, lactitol, and mixtures thereof.

24. The process of claim 23 wherein the disaccharide sugar alcohol is maltitol.

25. The process of claim 22 wherein the coating includes from about 10 to about 50 weight percent long-chain hydrogenated saccharide.

26. The process of claim 25 wherein the long-chain hydrogenated saccharide has a degree of polymerization of greater than 3.

27. The process of claim 22 wherein the coating includes from about 0 to about 3 weight percent monosaccharide sugar alcohol selected from the group consisting of sorbitol, erythritol, mannitol, xylitol, and mixtures thereof.

28. The process of claim 27 wherein the monosaccharide sugar alcohol is sorbitol.

29. The process of claim 22 wherein the coating includes from about 0 to about 3 weight percent polysaccharide sugar alcohol.

30. The process of claim 29 wherein the polysaccharide sugar alcohol is hydrogentated maltotriose.

31. The process of claim 22 wherein the coating is added to foods selected from the group consisting of nuts, seeds, cereal pieces, grains cookies, crackers, and mixtures thereof.
